(19) United States
(12) Patent Application Publication
(10) Pub. No.: US 2009/0290753 A1
(43) Pub. Date: Nov. 26, 2009

(54) METHOD AND SYSTEM FOR GAZE ESTIMATION

(75) Inventors: Xiaoming Liu, Schenectady, NY (US); Nils Oliver Krahnstoever, Schenectady, NY (US); Ambalangoda Gurunnanselage Amitha Perera, Clifton Park, NY (US); Anthony James Hoogs, Niskayuna, NY (US); Peter Henry Tu, Niskayuna, NY (US); Gianfranco Doretto, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/474,962

(22) Filed: May 29, 2009

Related U.S. Application Data
(63) Continuation-in-part of application No. PCT/US2007/081023, filed on Oct. 11, 2007.

(51) Int. Cl. G06K 9/00

(52) U.S. Cl. 382/100; 382/181

(57) ABSTRACT

A gaze estimation method and system, the method including capturing a video sequence of images with an image capturing system, designating at least one landmark in a head portion of the captured video sequence, fitting a virtual model of the head portion to the actual head portion in the captured video sequence, and determining the gaze estimation.

### CROSS REFERENCE TO RELATED APPLICATIONS

This application is a Continuation-in-Part of PCT/US2007/081023 filed Oct. 11, 2007 and claims benefit of and priority to U.S. Provisional Patent Application Ser. No. 60/869,216, filed on Dec. 8, 2006, entitled “METHOD AND SYSTEM FOR GAZE ESTIMATION”, the contents of which are incorporated herein by reference for all purposes.

### BACKGROUND

The present disclosure relates, generally, to gaze estimation. In particular, a system and method are disclosed for determining and presenting an estimate of the gaze of a subject in a video sequence of captured images.

Regarding captured video of various events, viewing of the video may allow a viewer to see the event from the perspective and location of the subject even though the viewer did not witness the event in person as it occurred. While the video may sufficiently capture and present the event, the presentation of the event may be enhanced to increase the viewing pleasure of the viewer. In some contexts, an on-air commentator may provide commentary in conjunction with a video broadcast in an effort to convey additional knowledge and information regarding the event to the viewer. It is noted however that care is needed by the on-air commentator not to say too much as to, for example, distract from the video broadcast.

In some embodiments, it would be beneficial to convey information and data regarding captured video to a viewer using a visualization mechanism as opposed to a spoken commentary. In this manner, the viewing of a video sequence of an event may be enhanced by efficient image visualizations that convey information and data regarding the event.

There have been efforts to provide computer vision field estimation. One conventional system employed appearance models of the human head under different gazes and processed the respective vision field. Once a new image was obtained, the image would be compared to each of the stored appearance models and the closest match was determined and used to estimate the vision field of the newly obtained image. Sufficient accuracy required a fairly large database of stored gazes for the comparison, which leads to slow processing time for the vision field estimation that is unable to accommodate a real-time or nearly real-time speed. Furthermore, in some applications the video images are unable to provide matching unless they are high resolution which is sometime unavailable.

### SUMMARY

One embodiment is a method for gaze estimation of a head portion, such as a helmet, cap, hat or head of a person using a computer readable medium having executable code, comprising capturing video sequences of images with an image capturing system and storing the video sequences on the computer readable medium, designating at least one landmark on the head portion of the video sequences, building a shape model and an appearance model of the head portion using the video sequences and the corresponding landmarks. The training portion of identifying the landmarks and building the shape and appearance model can be done off-line using prior video sequences. The processing includes developing a virtual head portion model for the head portion, wherein the virtual head portion model combines the shape model and appearance model, fitting the virtual head portion model to an actual head portion of the person in a subsequent video image, and determining the gaze estimation for the person in the subsequent video image.

A further feature includes processing telemetry data for the actual head portion over a plurality of sequential frames.

In one aspect, the fitting of the virtual head portion model to the actual head portion includes estimating resulting shape and appearance variation parameters that provide the gaze estimation of the person for a particular frame.

Another feature includes overlaying one or more boundary lines for the gaze estimation onto the video sequence and presenting on a broadcast video. This may include providing a display area in the video sequence with at least one of gaze estimation information or telemetry data.

One embodiment is a gaze estimation system for video sequences, including a computing system for storing the video sequences. There is a training section for designating a plurality of landmarks on a plurality of head portions in the video sequences and developing a virtual head portion model using an active appearance model with a shape and appearance component. A fitting section fits the virtual head portion model with an actual head portion of a person in the video sequences and estimating a gaze of the person for each frame of the video sequence. Broadcast equipment is used for broadcasting gaze information for display to a viewer.

### BRIEF DESCRIPTION OF THE DRAWINGS

FIG. 1 is an illustrative depiction of an image captured by an image capturing system, including gaze estimation overlays, in accordance with some embodiments herein;

FIG. 2 is an illustrative depiction of a re-visualization of an image captured by an image capturing system, including gaze estimation overlays, in accordance with some embodiments herein;

FIG. 3 is an illustrative depiction of an image captured by an image capturing system, including a display area, in accordance with some embodiments herein;

FIG. 4 is an exemplary illustration of a number of shape models, in accordance herewith;

FIG. 5 is an exemplary depiction of a number of appearance models, in accordance herewith;

FIG. 6A is an exemplary illustration of an image captured by an image capturing system, in accordance herewith;

FIG. 6B is an illustrative depiction of fitting a virtual model to an actual object used, for example, in association with the captured image of FIG. 6A, in accordance herewith;

FIG. 7 are illustrative graphical representations related to gaze estimation for the video images, in accordance with aspects herein;

FIG. 8 is an illustrative depiction of a captured image, including identification of regions of interest, in accordance with some embodiments herein; and

FIG. 9 is an illustrative perspective of a subject indicating the gaze estimation and telemetry information in an overlay and in a display window, in accordance with aspects herein.

### DETAILED DESCRIPTION

The present disclosure relates to video visualization. In particular, some embodiments herein provide a method, system, apparatus, and program instructions for gaze estimation of an individual captured by a video system.

A machine based gaze estimation process and system is provided that determines and estimates the gaze direction of an individual captured on a video sequence. Some embodiments further provide a visual presentation of the gaze estimation. The visual presentation or visualization of the gaze estimation may be provided alone or in combination with a video sequence and in a variety of formats. In some embodiments, a computer vision algorithm estimates the gaze of a subject individual. Portions of the process of estimating the gaze of the individual may be accomplished manually, semi-manually, semi-automatically, and automatically.

In some embodiments, the gaze estimation process comprises two processing stages or sections. A first section includes training for a number of video images, wherein a number of landmarks on the region(s) of interest are labeled. The landmark labeling operation may include manually designating the region(s) of interest given a sequence of video images. In the context of gaze estimation, the region of interest includes the head portion of subject individual for whom the gaze estimation is being determined. As used in this context, the head portion refers to the head or headgear worn on the head such as a helmet, cap or hat. A shape model is used to represent the shape of a region of interest (i.e., the head of a subject individual). The appearance model, such as texture information, is used in conjunction with the shape model to develop the virtual head portion model. In some embodiments, the shape model and appearance model are implemented as an Active Appearance Model (AAM) using, for example, two subspace models; a deformable model and/or a rigid model.

A second fitting section provides for using the models from the training for a video sequence and uses the AAM to fit the mesh or virtual head portion model to the actual head portion for each frame of the vide sequence by estimating the shape and appearance parameters for the subject individual. Based on the resulting shape parameter(s), an estimation of the gaze of the subject individual may be determined for each frame of the video sequence.

In some embodiments, the gaze estimation methods disclosed herein may efficiently provide gaze estimation in real time. For example, gaze estimation in accordance with the present disclosure may be performed substantially concurrent with the capture of video sequences such that gaze estimation data relating to the captured video sequences is available for presentation, visualization and otherwise, in real time coincident with a live broadcast of the video sequences.

The images used to learn an AAM may be, in some embodiments, relatively few as compared to the applicability of the AMM. For example, nine (9) images may be used to learn an AAM that in turn is used to estimate the gaze for about one hundred (100) frames of video.

In some embodiments, the gaze estimation methods disclosed herein may provide gaze estimation data even in an instance where low resolution video is used as a basis for the gaze estimation processing. By using AAM techniques to ascertain the shape and appearance of the subject individual, the methods herein may be effectively used with low resolution video images.

In some embodiments and contexts, the gaze estimation herein may be extended to subject individuals having at least a portion of their face obscured. For example, the gaze estimation methods, systems, and related implementations herein may be used to provide gaze estimation for subject individuals captured on video participating in various contexts and sporting events wherein the face and head of the subject individual is visually obscured, such as in football, hockey, and other activities where a helmet is worn.

In some embodiments, the gaze direction of a football player may be provided as an overlay in broadcast video footage, in real time or subsequently (e.g., a replay). In the context of a broadcast, on-air commentators may offer, for example, on-air analysis of a quarterback's decision process before and/or during a football play by visually showing the broadcast viewers via gaze estimation overlays how and when the quarterback scans the football field and looks at different receivers and/or defenders before making a football pass.

Gaze estimation overlays may be obtained using a variety of techniques, including a completely manual technique by a graphics artist without requiring specialized skills and knowledge from the computer vision domain to a fully automatic process employing computer vision technology.

Regarding a manual technique, an individual such as, for example, a graphic artist or special effects artist may visually inspect a sequence of video and manually draw lines in every video frame to visually indicate the gaze direction of the football player. In some embodiments, an on-air commentator may use a broadcast tool/process (e.g., a Telestrator®) to manually draw overlays into the broadcast that indicates gaze direction. In this manner, a gaze estimation visualization is provided as an improvement to the viewer experience.

In some semi-manual techniques for providing gaze estimation, an operator may manually inspect and draw gaze direction estimation indicators (e.g., lines, highlights, etc.) on certain frames of a sequence of video. The certain frames may be every few “key” frames of video in the footage. An interpolation operation may be performed on the non-key frames to obtain gaze direction estimates for every frame of the video.

In some embodiments, an operator may use a special tool to improve upon the accuracy and/or efficiency of the manual gaze direction estimation process in frames or key-frames. Such a tool may display a graphical model of a football player's helmet or an athlete's head, represented by points and/or lines. The graphical (i.e., virtual) model may be displayed on a display screen and, using a suitable graphical user interface, the location, scale, and pose of the model may be manipulated until there is a good visual match between the virtual model and the true helmet of the subject football player. Accordingly, the gaze direction of the subject player in the video footage would correspond to the pose of the virtual football helmet or head of the subject after alignment.

In some embodiments, a model of the head portion such as a football helmet may be a 3-D model that closely approximates or resembles an actual football helmet. In some embodiments, a model of the football helmet may be 2-D model that resembles the projection of an actual football helmet. Pose and shape parameters of the head portion model may be used to represent 3-D location and 3-D pose or be more abstract shape and appearance parameters may be used that describe the deformation of a 2-D model head portion in a 2-D image.

In some embodiments, the gaze estimation capture tool may further use knowledge about a broadcast camera that recorded the video footage. In particular, the location of the camera with respect to the field, the pan, tilt and roll of the camera, the focal length, the zoom factor, and other parameters and characteristics of the camera may be used to effectuate some gaze estimations, in accordance herewith. This camera knowledge may define certain constraints regarding the possible locations of the virtual head portion in the video imagery, thereby aiding the alignment process between the virtual model head portion and the captured video footage for the operator. The constraints arise because the head portion of the subject is, in practical terms, typically limited to between about 10 cm and about 250 cm above the football field and is typically limited to a fixed range of poses (i.e., a human primarily pans and tilts).

Also, the gaze estimation capture tool may use multiple viewing angles of a football player. Given accurate camera information for multiple viewing angles, the operator may perform the alignment process between the virtual model and the actual video footage based on multiple viewing directions simultaneously, thereby making such alignment processes more accurate and more robust.

In some embodiments, a semi-automatic approach for providing a gaze estimation overlay includes associating a virtual model of the helmet/head of the subject individual with appearance information such as, for example, “image texture”. The appearance information facilitates the generation of a virtual football helmet/head that appears substantially similar to the actual video captured helmet/head in the broadcast footage. In the instance of such an accurate model, the alignment between the virtual helmet and the image of the helmet may be automated. In some embodiments, an operator may initially bring the virtual helmet into an approximate alignment with the actual (i.e., real) helmet and an optimization algorithm may further refine the location and pose parameters of the virtual helmet in order to maximize a similarity between the video footage's real helmet and the virtual helmet.

In some embodiments, the automatic refinement may be selectively or exclusively performed with shape information (i.e., without appearance information in some instances) by performing a manual or purely shape based alignment once, that is then followed by an acquisition of appearance information from the video footage (e.g., texture information is mapped from the broadcast footage onto the virtual model of the head portion). Subsequent alignments may then be performed using the acquired appearance information.

The amount and degree of operator intervention may be further reduced to a single rough alignment between the virtual head portion and the head portion of the broadcast footage by using the automatic pose refinement incrementally. For example, after an alignment has been established for one frame, subsequent alignments may be obtained by maximizing the similarity between the model and the capture imagery, as described hereinabove.

In a fully automatic approach for providing a gaze estimation overlay, operator intervention may be eliminated by developing and using subject (e.g., football player or helmet) detectors. The detector may include an algorithm that automatically determines the location of the subject or subject body (e.g., head portion) in a sequence of video images. In some embodiments, the detector may also include determining at least a rough pose of an object or person in a video image.

In some embodiments, one or more cameras may be used to capture the video. It should be appreciated that the use of more than one camera to yield video containing multiple viewing angles of a scene may contribute to providing a gaze direction estimation that is more accurate that a single camera/single viewing angle approach. Furthermore, knowledge regarding the camera parameters may be obtained from optoelectronic devices attached to the broadcast cameras or via computer vision means that match 2-D image points field with 3-D world coordinate points of a video captured environment (e.g., a football field).

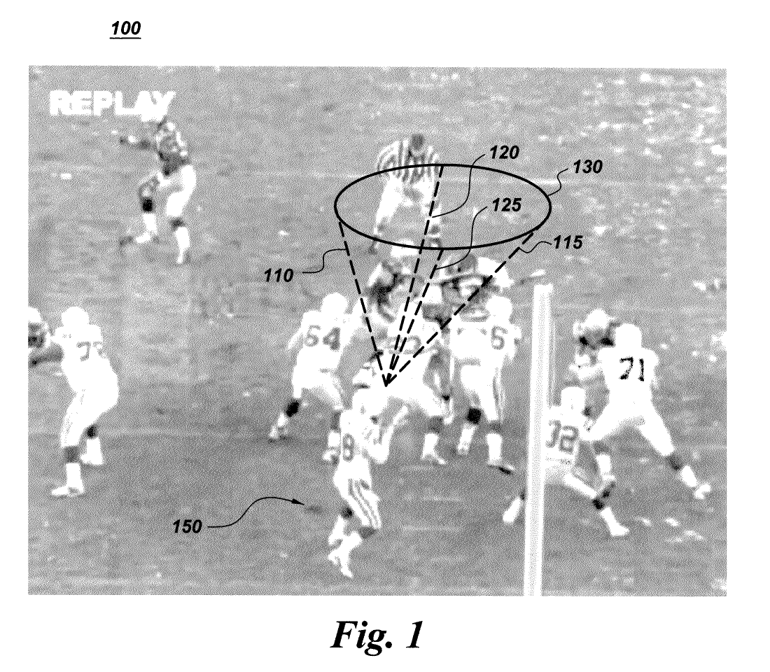

FIG. 1 is an exemplary illustration of a video image 100 including gaze estimation overlay. The gaze estimation presents a visualization of the field of vision of player 150 at a given instant in time. The gaze estimation overlay includes boundaries 110, 115, 120, and 125 that define the boundaries of the field of vision of the subject player 150 in the video scene. Boundary marking 130 further defines the field of vision. Gaze estimation may be obtained using one or more of the gaze estimation techniques disclosed herein.

The boundaries 110, 115, 120, and 125 for the gaze estimation overlay in one embodiment are established using typical human field of vision parameters that indicate the expanded breadth of the gaze cone as the distance from the player increases. In another embodiment, the field of vision parameters are adjusted according to the helmet that may restrict peripheral vision. Similarly, the field of vision can be tailored to the individual player 150.

In this example, a quarterback in a football game is the subject player 150 and he is approximately stationary in this frame. The system has processed prior video sequences in the training stage to label landmarks on the helmet of the quarterback to capture time varying shape model and appearance of the helmet and provide for helmet localization. The landmarks may be, for example, the logos or designs on the helmet. The active appearance model (AAM) is developed to represent the shape and appearance of the helmet using subspace models. For any subsequent video sequence, the AAM fits the mesh or virtual model to the quarterback's helmet by estimating the shape and appearance parameters. The processing is in real-time without a matching to a plurality of other frames of the helmet. Furthermore, the fitting of the mesh model operates with lower resolution images than the conventional matching systems. The resulting shape parameter of the helmet identifies the position and angular position of the helmet and is directly used for the gaze estimation of the quarterback for a particular frame. The boundaries for the gaze estimation overlay are then established to indicate the approximate location downfield for the estimated gaze of the quarterback at a particular frame. It should be apparent that the gaze estimation is not limited to the quarterback and can be used to estimate the gaze of any player. For example, the gaze estimation can be used for a receiver running downfield or a defensive player that may be trying to sack the quarterback.

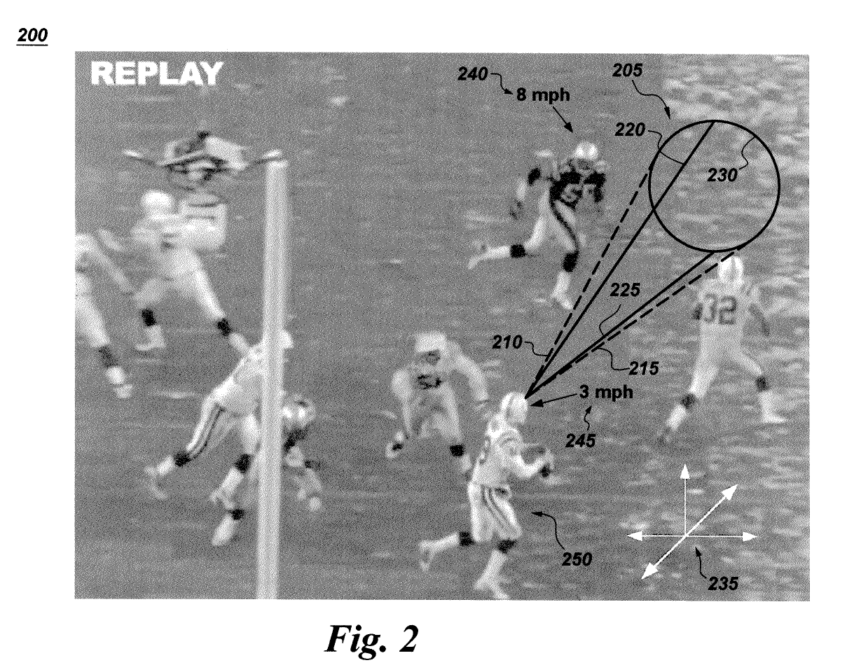

FIG. 2 provides an exemplary illustration of video image 200, including the gaze estimation overlay 205 as well as telemetry information 240, 245. In this example, the subjects, namely players, are in motion, and the gaze estimation overlay 205 is provided in conjunction with other visualizations such as telemetry components 240, 245 that provide telemetry details of the subjects in the video. The telemetry information 240, 245 in one embodiment is gaze tracking that is obtained from the gaze estimation over a number of sequential video sequence frames. For example, the movement across each frame can be used by processing the distance change over one or more frames and using the time for the frames to process information such as the velocity and/or acceleration.

Gaze estimation overlay 205 for the subject player 250, the quarterback in this example, includes boundaries 210, 215, 220, 225, and 230 that define the boundaries of the subject player's (250) field of vision in the video scene. Gaze estimation overlay 205 is continuously updated as the video sequences 200 changes to provide an accurate, real time visualization of the gaze direction of player 250. A directional icon 235 is provided in this illustration to inform viewers of the frame of reference and orientation used in the determination and/or presentation of the gaze estimation overlay and telemetry data.

In this example, the quarterback is moving towards the right at approximately three miles per hour. A defensive player is also moving towards the right at approximately eight miles per hours. The speed and direction of the players is obtained through visual telemetry and provides information such as velocity, acceleration, distance traveled and energy expended. The visual telemetry for the various players is processed after the helmets are processed and the mesh models are determined. In one embodiment, the visual tracking is accomplished by using a mean-shift filter to track the helmets of interest over time via the video sequences. The movement of the helmets is tracked for each frame or groups of sequential frames to ascertain the movement and since the time between each frame is known, the telemetry data is processed. In this example, the video is a replay and allows the viewer to obtain a different perspective with the telemetry data and gaze estimation overlay.

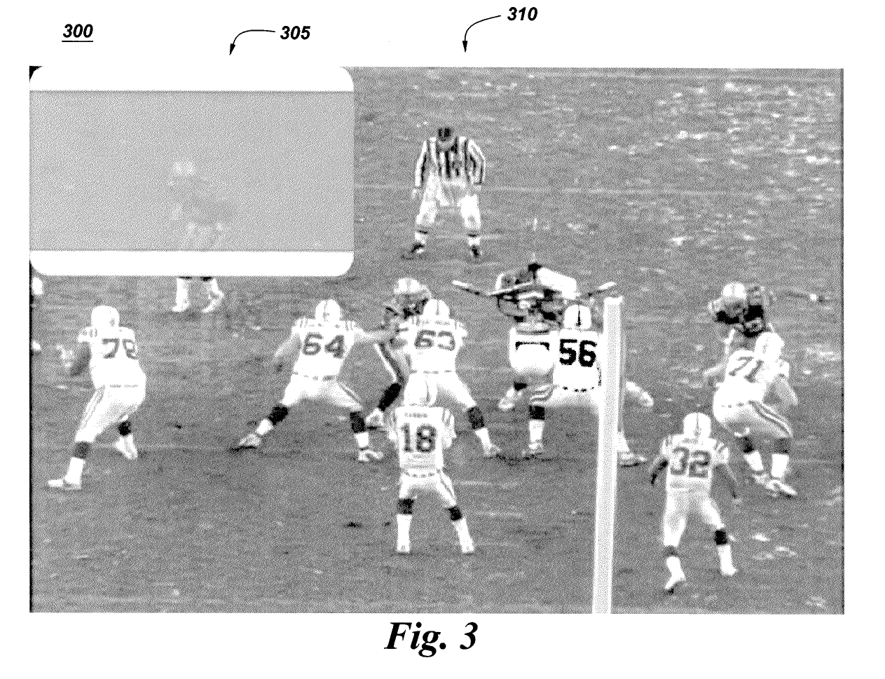

FIG. 3 provides an exemplary video image 300 including a display area 305 on the video image 310. Display area 305 may be used to display textual and/or descriptive information regarding a gaze estimation and/or gaze tracking determination for the video image 310 which can include subject, game or field specific information. As noted, the gaze tracking combines the region of interest identification (e.g.: helmet identification) with the gaze estimation and involves the dynamic processing over a number of frames of the video sequence. For example, gaze tracking may be performed for a player in video image 310, but instead of an overlay being generated and visualized thereon, display area 305 may be used to display textual and/or descriptive information. For example, the textual and/or descriptive information may include a gaze angle, rate of change in the gaze angle, maximum distance downfield included in the gaze estimation, and other gaze related information. This can also include player identification, game information and field information to provide a full breadth of details for the viewer.

By way of illustration of one example, the helmet identification for the particular players in the video sequences is performed manually, or based on helmet tracker or player tracking system. The gaze estimation is performed for a number of frames of the video using the mean-shift filter. The gaze tracking thus provides for tracking of the helmets and players, wherein the display area can be used to highlight certain data.

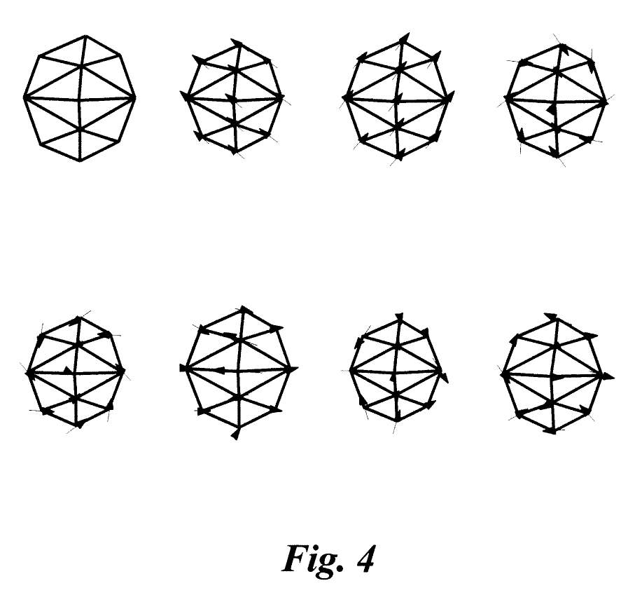

FIG. 4 is an illustrative depiction of a number of images of head portions used in training for the shape models. In this example there are a plurality of landmarks or points such as eleven landmarks used to generate the shape model for the head portions. The number of points is typically determined according to the circumstances and a greater number of points provide greater resolution. Arrows on the shape model provide, for example, an indication of the variability of the particular head portion. As shown, the head portions have different sizes and orientation such that the arrows provide a visual presentation of the bias or variability. The normalized head portion of the shape model is shown in the upper left.

In one example, the system processes prior video sequences in a training stage to label landmarks on the helmet of the player to capture time varying shape model and appearance model of the helmet and provide for helmet localization. The active appearance model is developed for capturing the shape and appearance of the helmet. In one example, the active appearance model processes a virtual head portion using the shape and appearance model. For any subsequent video sequence, the virtual head portion model is fit to the player's head portion by estimating the shape and appearance parameters. Fitting of a particular virtual head portion model to the actual head portion establishes the shape instance providing the gaze estimation of the player for that frame. The shape instance represents the variation or difference from the normalized virtual head portion and thereby indicates the change in tilt or angle that shows the gaze estimation. In one example the tilt represents the field of vision movement across the field across one axis such as right or left of center. In another example the tilt indicates the field of vision movement in the up or down axis. Still another embodiment is a combination of the dimensions so that the gaze estimation shows multiple dimensions.

The basic processing of the AAM is described in particular detail in the commonly assigned application Ser. No. 11/650,213 filed Jan. 05, 2007, entitled “A METHOD OF COMBINING IMAGES OF MULTIPLE RESOLUTIONS TO PRODUCE AN ENHANCED ACTIVE APPEARANCE MODEL”, which is incorporated by reference herein.

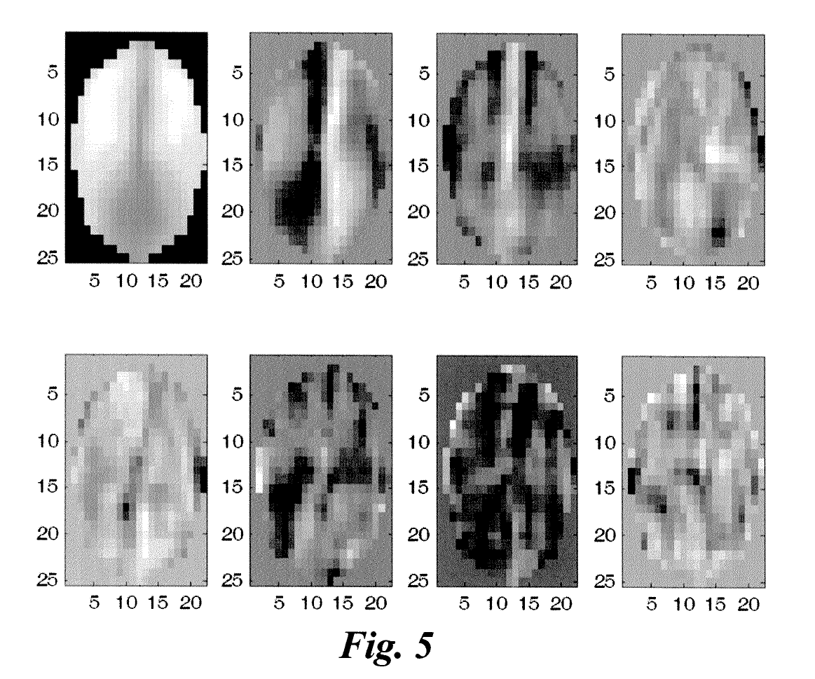

According to one embodiment, the AAM is composed of a shape model and an appearance model, wherein the shape model is shown in FIG. 4 and the appearance model is shown in FIG. 5. The AAM is trained to align images by resolving calculations from both the shape model and the appearance model. The distribution of landmarks for the shape model is modeled as a Gaussian distribution. One method of building a shape model is as follows. Given a database with M video images containing the head portions, each of them Iₘ are manually labeled with a set of landmarks, [xᵢ, yᵢ] i=1, 2, . . . , v. The collection of landmarks of one image is treated as one observation for the shape model, s=[x₁, y₁, x₂, y₂, . . . , xᵥ, yᵥ]^{T}. Finally eigenanalysis is applied on the observations set and the resultant linear shape space can represent any shape as:

$$s ( P ) = {s}_{0 } + {\sum }_{i = 0}^{n} {p}_{i} {s}_{i}$$

where s₀ is the mean shape, sᵢ is the shape bias, and P=[p₁, p₂, . . . , pₙ] is the shape coefficient.

Referring again to FIG. 4, with the exception of the normalized model shown on the upper left, all the other shape biases represent the global rotation and translation for landmarks wherein the arrow direction and length are indicative of the bias. Together with other shape bias, a mapping function from the model coordination system to the coordination in the image observation can be defined as W(x;P), where x is the pixel coordinate in the mean shape s₀. The image on the upper left without any arrows represents the mean or average shape model. In one example, multiple video images of the head portions can be processed to provide a mean shape model.

After the shape model is trained, the appearance model is processed. FIG. 5 shows a number of appearance models and the mean appearance model is shown on the upper left. Each video image of the head portion is warped into the mean shape based on the piece-wise affine transformation between its shape instance and the mean shape. These shape-normalized appearances from all training images are feed into eigenanalysis and the resultant model can represent any appearance as:

$$A ( x ; λ ) = {A}_{0} ( x ) + {\sum }_{i = 0}^{m} {λ}_{i} {A}_{i} ( x )$$

where A₀ is the mean appearance, Aᵢ is the appearance bias, and λ=[λ₁, λ₂, . . . λₙ] is the appearance coefficient. In an exemplary implementation, the resolution of the appearance model is the same as the resolution of training images.

From the modeling side, the AAM generated from this processing can synthesize head portion images with arbitrary shape and appearance within a certain population. On the other hand, model fitting is used by the AAM to explain a head portion image by finding the optimal shape and appearance coefficients such that the synthesized image is closer to the image observation. This use of model fitting leads to the cost function used in model fitting:

$$J ( P , λ ) = {\sum }_{X ∈ {S}_{0}} {‖ I ( W ( x ; P ) ) - A ( x ; λ ) ‖}^{2}$$

which minimizes the mean-square-error between the image warped from the observation I(W(x; P)) and the synthesized appearance model instance A(x;λ).

Traditionally, the minimization problem is solved by iterative gradient-decent method, which estimate ΔP, Δλ and adds them to P, λ. Algorithms called inverse compositional (IC) method and simultaneously inverse compositional (SIC) methods typically improve the fitting speed and performance. The basic idea of IC and SIC is that the role of appearance template and input image is switched when computing ΔP, which enables the time-consuming steps of parameter estimation to be pre-computed and outside of the iteration loop.

In an exemplary embodiment, the system and method described herein uses an AAM enhancement method to address the problem of labeling errors in landmarks. Starting with a set of training images and their corresponding manual landmarks, an AAM is generated as follows. The training images are fitted in AAM using the SIC algorithm. The initial landmark location for the model fitting is the manual landmarks. Once the fitting is completed, differences between the new set of landmarks and previous set of landmarks are calculated. If the difference is above a set threshold, a new iteration of the AAM enhancement method begins and a new set of landmarks is obtained. The iteration continues until there is no significant difference between the landmark set of the current iteration and the previous iteration.

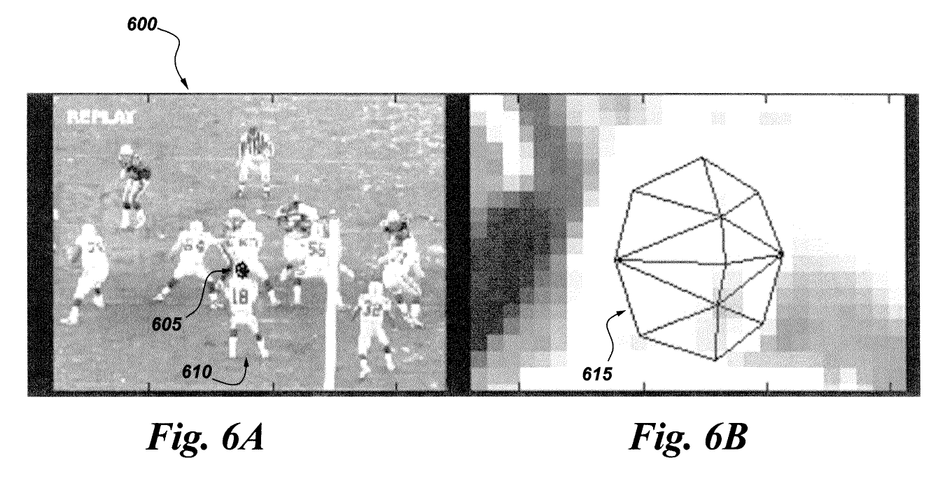

FIG. 6A is an illustrative depiction of a video image 600 including a helmet 605 worn by football player 610. That is, helmet 605 is the actual or real helmet shown in the video. FIG. 6B represent the fitting of the virtual helmet model 615 to the actual helmet 605. The alignment of virtual helmet model 615 with the low-resolution image of the helmet 605 is accomplished using one or more of the techniques disclosed herein. The shape instance represents the variation from the virtual helmet model as compared with the actual helmet 605 for that particular frame and thereby provides the gaze estimation.

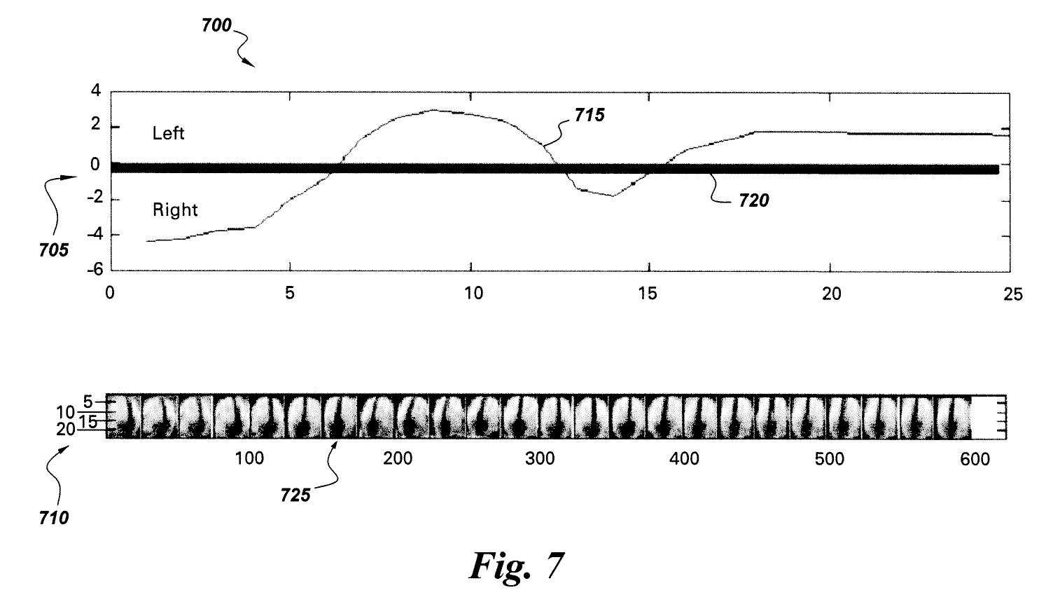

FIG. 7 provides an exemplary graphical presentation 700 relating to gaze estimation for a video image. Section 705 includes graph line 715 that tracks or represents the gaze direction (i.e., angle) over a period of time. The angle of the subject's helmet/head is determined relative to a central or neutral position 720 (i.e., gaze angle of 0°). Section 710 includes a segment of the video including images of the helmet of the player 725 over a number of video frames whose gaze is being determined and corresponds to the line graph in section 705. Each of the helmet images 705 are processed and the tilt or angular displacement is noted on the right and left axis of the graph 705. For example, the lowest portion of the graph at −4 represents the maximum right tilt that is illustrated by the corresponding helmet on the time line 710. Likewise the maximum point on the graph is indicative of the maximum left tilt as shown by the corresponding helmet.

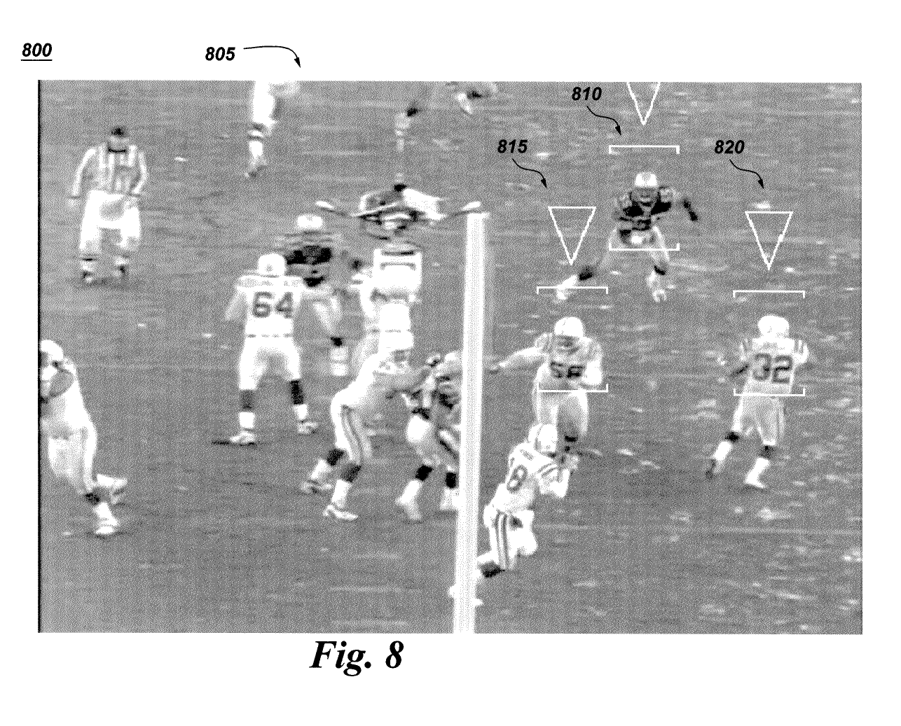

FIG. 8 is an illustration 800 of video image 805 including visualizations of subject detections. A detector method and/or system may be used to detect, in real time or subsequent thereto, namely the helmet/head of interested subjects (e.g., football players) in video image 805. As shown, graphic overlays 810, 815, and 820 visually indicate the detected helmets/heads of, for example, three players. In some embodiments, graphic overlays 810, 815, and 820 may be visualized to indicate the players in the field of vision for another player, such as the quarterback in video image 805. In this manner, gaze estimation data is also provided to a viewer. Each helmet can be processed and the mesh model is fitted to the helmet to determine the gaze estimation.

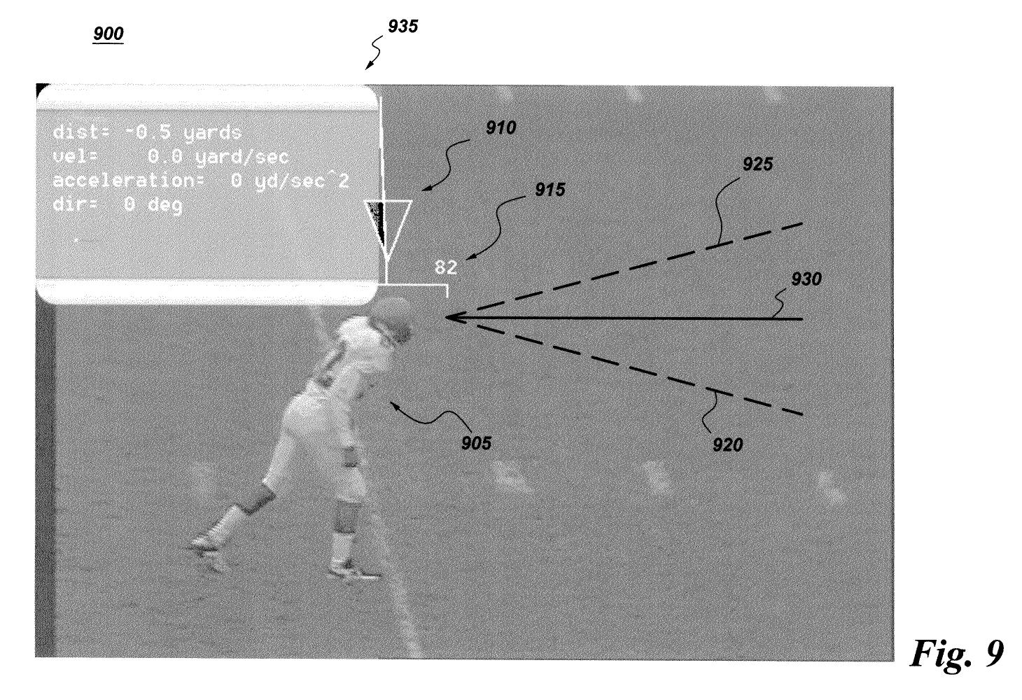

FIG. 9 is an exemplary depiction 900 of a gaze estimation overlay for a video image. The gaze estimation is provided and associated with player 905. The player's jersey number is provided at 915, in close proximity with graphic overlay 910 that tracks the player's helmet. Graphic overlay 910 may be obtained using, though not necessarily, an automatic helmet detector method and system. The gaze direction of player 905 is visualized by a center line 930 and boundaries 920 and 925. In some embodiments, boundaries 925 and 920 may be based on a theoretical or even an estimated range of vision for player 905. In some embodiments, boundaries 925 and 920 may be offset from center line 940 based on a calculation using data specific to the actual range of vision for the player 905.

Display area 935 includes graphical information relating to player 905. The information shown relates to the position of player to a reference point of the field (e.g., line of scrimmage), velocity and acceleration for player 905. Also included is the gaze direction (0°) for the player. It should be appreciated that additional, alternative, and fewer data may be provided in display area 935.

In some embodiments, gaze overlay information, including the visualization of same, may be presented as lines (solid, dashed, colored, wavy, flashing, etc.) in a 2-D presentation or a 3-D presentation that includes height (up and down), width (side-to-side), and depth (near to far) aspects of an estimated and determined field of vision. The 3-D presentation may resemble a “cone of vision”.

Also, the gaze overlay information may be provided on-screen with a sequence of video images as graphical or textual descriptions. In some embodiments, a frame of reference for the gaze estimation may be presented as and include, for example, a line graph, a circle graph with indications of the gaze estimation therein, a coordinate system, ruler(s), a grid, a gaze angle and time graph, and other visual indicators. In some embodiments, an angle velocity indicative of a rate at which a subject individual changes their gaze direction may be provided. In some embodiments, gaze estimation may be presented on a video image in a split-screen presentation wherein one screen area displays the video without the gaze estimation overlay and another screen displays the video with the gaze estimation overlay. In some embodiments, an indication of a gaze estimation may be presented or associated with or in a computer-generated display or computer visualization (e.g., a PC-based game image, a console game image, etc.).

While the examples have illustrated football players and processing of helmets for the gaze estimation, the system operates with other types and forms of helmets and heads and other sports such as soccer, hockey and lacrosse.

While the disclosure has been described in detail in connection with only a limited number of embodiments, it should be readily understood that the disclosure is not limited to such disclosed embodiments. Rather, the disclosure embodiments may be modified to incorporate any number of variations, alterations, substitutions or equivalent arrangements not heretofore described, but which are commensurate with the spirit and scope of the invention. Accordingly, the disclosure is not to be seen as limited by the foregoing description.

What is claimed is:

1. A method for gaze estimation of a head portion of a person using a computer readable medium having executable code, comprising:
capturing video sequences of images with an image capturing system and storing said video sequences on said computer readable medium;
designating at least one landmark on the head portion of the video sequences;
building a shape model and an appearance model of the head portion using the video sequences and the corresponding landmarks;
developing a virtual head portion model for said head portion, wherein said virtual head portion model combines the shape model and appearance model;
fitting the virtual head portion model to an actual head portion of the person in a subsequent video image; and
determining said gaze estimation for the person in the subsequent video image.

2. The method of claim 1, wherein the shape model and appearance model are processed as an active appearance model using at least one a deformable subspace model or a rigid subspace model.

3. The method of claim 1, wherein determining said gaze estimation is performed in real time.

4. The method of claim 1, wherein the building uses prior video sequences and is performed off-line.

5. The method of claim 1, wherein the head portion is a helmet, hat, cap or head.

6. The method of claim 1, further comprising processing telemetry data for the actual head portion over a plurality of sequential frames.

7. The method of claim 1, wherein the fitting of the virtual head portion model to the actual head portion comprises estimating resulting shape and appearance variation parameters that provide the gaze estimation of the person for a particular frame.

8. The method of claim 1, further comprising overlaying one or more boundary lines for the gaze estimation onto the video sequence and presenting on a broadcast video.

9. The method of claim 1, further comprising providing a display area in the video sequence with at least one of gaze estimation information or telemetry data.

10. The method of claim 1, wherein labeling of the landmark is performed manually or semi-automatically.

11. The method of claim 1, wherein fitting the virtual head portion model to the actual head portion is one of semi-automated or automated.

12. The method of claim 1, wherein said fitting includes initially aligning said virtual head portion model to the actual head portion.

13. The method of claim 1, further comprising producing a multi-dimensional head portion model approximating the actual head portion, wherein the multi-dimensional model is two dimensional or three dimensional.

14. A gaze estimation system for video sequences, comprising:
a computing system for storing the video sequences;
a training section for designating a plurality of landmarks on a plurality of head portions in the video sequences and developing a virtual head portion model using an active appearance model with a shape and appearance component;
a fitting section that fits the virtual head portion model with an actual head portion of a person in the video sequences and estimating a gaze of the person for each frame of the video sequence; and
broadcast equipment for broadcasting gaze information for display to a viewer.

15. The system of claim 14, wherein the gaze information is at least one of telemetry data of the person or boundaries of the gaze estimation.

16. The system of claim 14, wherein the estimating a gaze of the person comprises determining a shape instance that represent the changes between the virtual head portion model and the actual head portion.
